(19) United States
(12) Patent Application Publication
(10) Pub. No.: US 2020/0285292 A1
(43) Pub. Date: Sep. 10, 2020

(54) POWER ADAPTERS FOR COMPONENT INTERCONNECT PORTS

(71) Applicant: Hewlett-Packard Development Company, L.P., Spring, TX (US)

(72) Inventors: Peter Seiler, Fort Collins, CO (US); Amol Subhash Pandit, Fort Collins, CO (US)

(73) Assignee: Hewlett-Packard Development Company, L.P., Spring, TX (US)

(21) Appl. No.: 16/756,153

(22) PCT Filed: Nov. 6, 2017
(86) PCT No.: PCT/US2017/060152

§ 371 Date: Apr. 15, 2020

(51) Int. Cl. G06F 1/26; G06F 13/40

(52) U.S. Cl. CPC G06F 1/266; G06F 2213/0026; G06F 13/4068

(57) ABSTRACT

An example power adapter for component interconnect ports may comprise an interconnect portion to receive power from a first computing component interconnect port without transmitting or receiving data via the first computing component interconnect port. The power adapter may also comprise a power output portion for transmitting received power to a computing component.

### BACKGROUND

Computing devices may use computing components to enable, augment, or improve functionality. For instance, computing components may include graphical processing components, such as may be installed in computing devices to provide augmented graphical processing capabilities to the computing device. At times, computing components receive power via a motherboard of a computing device. At times, computing components may use power received via an auxiliary power connection directly from a power supply of the computing device.

### BRIEF DESCRIPTION OF THE DRAWINGS

Various examples will be described below by referring to the following figures.

FIG. 1 is a block diagram illustrating of an example power adapter;

FIG. 2 is a perspective view of a sample PCB having component interconnect ports;

FIG. 3 is a profile view of an example PCB with a computing component and a power adapter connected to component interconnect ports;

FIG. 4 is a profile view of an example power adapter; and

FIGS. 5A and 5B are schematic illustrations of example combinations of computing components and power adapters.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration.

### DETAILED DESCRIPTION

At times, functionality of computing devices may be enabled, increased, and/or augmented by use of computing components (e.g., physical parts of a subsystem of a computing device). To illustrate, example computing components may include components for storing and/or reading signals and/or states stored to media, such as digital versatile disc (DVD) players, hard disk drives (HDD), flash drives, phase-change media drives, removable media readers, and the like; example computing components may also include components for wired and/or wireless interfaces, such as universal serial bus (USB), THUNDERBOLT, Ethernet, WIFI, BLUETOOTH, and near-field communication (NFC) interfaces, and the like; and components for specialized (e.g., application-specific) processing, such as graphics processing or compute cards, by way of non-limiting example.

There may exist a number of possible methods and mechanisms for providing power (e.g., electrical power) to computing components of a computing device (e.g., directly from a wall outlet, from a battery, etc.). In one implementation, power may be transmitted to computing components from a power supply of a computing device. A power supply refers to a component of a computing device that may convert power of one form (e.g., from a wall outlet) into a second form (such as for components of the computing device). For example, one power supply may convert alternating current (AC) power from a wall outlet into direct current (DC) power for computing components.

In one example case, power from a power supply may be fed directly to certain computing components (e.g., HDDs, SSDs, and/or DVD drives of a computing device), such as via wires and a wiring harness. The power supply may also transmit power to a printed circuit board (PCB), such as a motherboard, of a computing device for allocation to other computing components. For instance, the PCB may comprise circuitry to provide power to additional computing components. By way of example, the PCB may comprise connectors for peripheral interface components, such as graphical processing components (e.g., that may be connected to a display), and other interface components, such as networking components (e.g., WIFI card, Ethernet card, etc.), and the like. Power may be transmitted via the connectors according to industry standards, which is to be understood to include standards yet to be established in the future. For example, peripheral component interconnect (PCI), PCI eXtended (PCI-X), and PCI Express (PCIe) are example component connector ports (referred to alternatively herein as interconnect slots) that may have respective power transmission standards, including limits on power levels that may be transmitted via a particular component interconnect slot. For example, some PCIe ports may be limited to providing 25 W of power to connected devices, which may be dependent on a number of power and ground signals for a given interconnect slot. However, at times, some computing components may use power that exceeds the limits of power available through a particular component interconnect slot.

In one case (such as to overcome power limits of a particular component interconnect slot), supplemental power may be provided to computing components via an empty component interconnect slot of a PCB using a power adapter connectable to the empty component interconnect slot. By way of example, a computing component may be connected to a first component interconnect slot, and a power adapter may be connected to a second component interconnect slot. Power may be transmitted to the computing component via the first component interconnect slot and also, using the power adapter, power may be transmitted to the computing component via the second component interconnect slot. As such, computing components may be able to use a power adapter connected to additional interconnect slots to achieve desired power levels (e.g., such as in cases of computing components having power usage that exceeds power availability through a single component interconnect slot).

There may also be size-related constraints on power adapters. For example, some computing components may have a width extending beyond a particular component interconnect slot and potentially impeding access to neighboring component interconnect slots. For example, as computing components for graphical processing (e.g., graphical processing cards) increase in power, a size of the computing components may also increase, such as due to increases in size and/or number of electrical, thermal, and mechanical elements thereof. As a result, some computing components for graphical processing may extend over (e.g., cover) neighboring PCIe slots. However, in some cases, a power adapter may be sized to allow the power adapter to be connected to component interconnect slots covered by computing components.

Because it may be desirable to use otherwise unoccupied component interconnect slots (to which additional power has been allocated), example interconnector power adapters may be capable of connecting to component interconnect slots associated with (e.g., in communication with) empty processor sockets or ports. Said otherwise, in cases in which a power adapter is used to provide supplemental power to a computing component connected to another component interconnect slot, data may not be transferred via the power adapter. In fact, in some cases, the power adaptor may not include contacts to enable data transfer.

With the foregoing in mind, implementations of claimed subject matter may comprise multiple power adapters used in combination to provide power to a computing component from multiple component interconnect slots, without limitation.

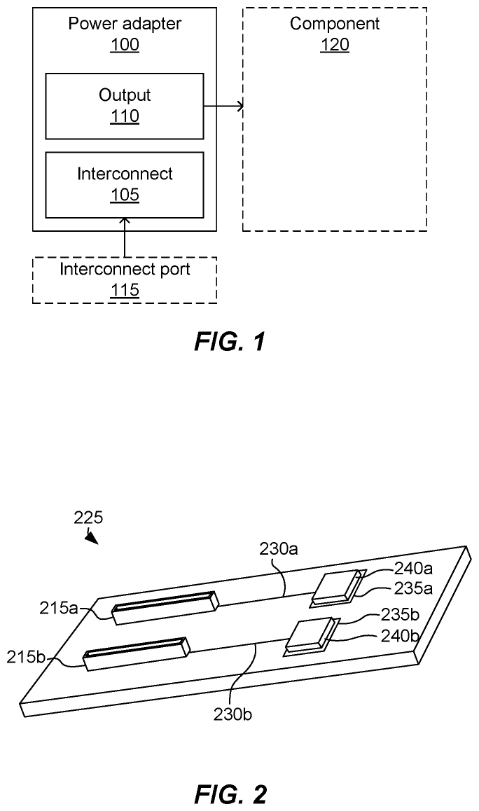

FIG. 1 is a block diagram illustrating an example power adapter 100, such as may be usable for providing supplemental power to a computing component. Computing component 120 may comprise, for example, a graphical processing component, and may use more power than may be provided by a component interconnect slot to which it is connected. As such, power adapter 100 may be capable of transmitting supplemental power from another component interconnect slot to component 120.

In one implementation, for example, power adapter 100 may comprise an interconnect 105. Interconnect 105 may comprise a portion that is connectable to a port, such as a component interconnect slot (e.g., interconnect slot 115). Interconnect 105 may comprise contacts capable of forming an electrical connection with contacts of interconnect slot 115. In one case, for example, interconnect 105 may comprise contacts for receiving power but not contacts for transmitting data signal packets.

Power may be transmitted from power adapter 100 (e.g., to component 120) via an output 110. For example, output 110 may be connected to an auxiliary power connection of a computing component, such as computing component 120, via a wire or cable.

In a case in which power adapter 100 comprises a number of portions for receiving and transmitting power, an interconnect portion, interconnect 105, may receive power from interconnect port 115. As noted, the interconnect portion may receive power via interconnect port 115 without transferring or receiving data via interconnect port 115. And an output portion, such as output 110, may transmit power (e.g., the power received via interconnect 105), such as to component 120, which may be arranged within (e.g., connected to) a second interconnect slot (e.g., distinct from interconnect slot 115). Of course, implementations using an integrated receiver/transceiver portion is also contemplated by the present disclosure.

Example interconnect ports may include PCIe slots. In one example implementation, for example, a power adapter may be capable of receiving power from a PCIe slot and transmitting the received power to a computing component, such as a graphical processing component in another PCIe slot. For example, the graphical processing component, which may use 150 W to operate, may be connected to (e.g., inserted within) a PCIe slot with a 75 W power limit. Consequently, power adapter 100 may be connected to (e.g., inserted into) a second PCIe slot, and 75 W of additional power may be transferred to the graphical processing component via power adapter 100. Of course, the foregoing sample numbers are provided for illustration and are not to be taken in a limiting sense.

In this example, the graphical processing component (e.g., computing component 120) may overhang a neighboring PCIe slot (e.g., interconnect slot 115). In such a case, power adapter 100 may be sized to connect to the neighboring PCIe slot, which PCIe slot may have otherwise remained empty due to the overhang from component 120, and be able to nevertheless transmit power from the PCIe slot to component 120. For example, power adapter 100 may be sized and arranged underneath an electromechanical space of component 120.

In a case in which PCIe slots are associated with different processor sockets, if one of the processor sockets is empty (e.g., no processor is installed), power may nevertheless be allocated and provided to PCIe slots associated with the empty processor socket. Consequently, the PCIe slots for which no processor is installed in the respective processor sockets, may be otherwise unusable for transmission and reception of data. Nevertheless, in the context of transmitting supplemental power to component 120, the PCIe slots associated with empty processor sockets may still be usable, such as to provide supplemental power to component 120.

Similarly, power adapter 100 may limit signals received (e.g., via interconnect 105) to power and ground signals (e.g., such as via a power connector or contact). Thus, power adapter may be capable of receiving and transmitting power without transmission of data signals. Indeed, in some cases, power adapter 100 may be unable to transmit data signals, such as due to a lack of data connectors, an inability to transmit data to other components, a lack of circuitry to handle data, etc.

In addition to the preceding PCIe examples, other example uses of power adapter 100 may comprise use in conjunction with PCI slots, PCI-X slots, and the like (including interconnect port standards to be developed in the future, and for which power output may be limited, such as by a standard), without limitation.

FIG. 2 is a perspective view of a sample PCB 225 having two component interconnect ports, component interconnect slots 215a and 215b. Interconnect slots 215a and 215b may be in electrical communication with processors 240a and 240b via traces 230a and 230b and sockets 235a and 235b. FIG. 2 illustrates a case in which PCB 225 comprises a plurality of processors 240a and 240b. In a case in which data transfer is desired, data exchanged via interconnect slot 215a may be handled by processor 240a, and data exchanged via interconnect slot 215b may be handled by processor 240b. However, in contrast to data transfer, power may be exchanged without intervention from a processor. Thus, at times, a processor socket, such as socket 235b, may be empty. Nevertheless, and as noted above, power may still be provided via interconnect slot 215b in cases in which processor 240b is not installed in socket 235b.

In one implementation, sockets 235a and 235b may be generalized to represent root ports. For example socket 235a may refer to a first root port associated with a first processor, a chipset, or an additional like root port source (e.g., additional processors, PCIe switch, etc.). And socket 235b may refer to a second root port associated with a second processor, a chipset, or an additional like root port source. And PCB 225 may include additional root ports associated with additional interconnect slots.

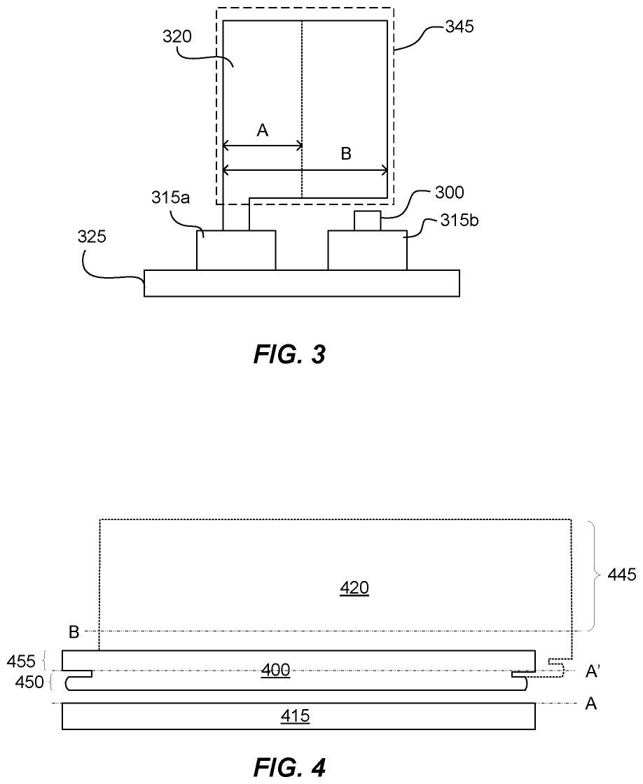

Additionally, at times, a component connected to one component interconnect slot, such as interconnect slot 215a, may extend over a second component interconnect slot, such as interconnect slot 215b. In such a case, interconnect slot 215b may not be accessible, such as for connecting computing components. However, a power adapter, such as power adapter 100 in FIG. 1, may be sized to be connected to interconnect slot 215b. For example, the power adapter may be sized to fit under an electromechanical space of the computing component. An example power adapter capable of fitting under an electromechanical space of a computing component is discussed in relation to FIG. 3, discussed hereinafter.

FIG. 3 is a profile view of a sample PCB 325 having two interconnect slots 315a and 315b. As shown in this implementation, a computing component 320 is connected to interconnect slot 315a and power adapter 300 is connected to interconnect slot 315b. Computing component 320 is a dual-width component, having, for example, a width that exceeds (e.g., is approximately two times) that of a standard component size (e.g., such as set by a standards body, by way of non-limiting example). For example, for component interconnect ports, such as interconnect slot 315a, a standard width of computing component 320 is indicated by width A. A dual-width component, such as computing component 320, may have a width of approximately width B. As shown, due to the dual-width nature of computing component 320, interconnect 315b is obscured and may be otherwise unusable. It is to be understood that though dual-width components are discussed and shown in the examples of the present disclosure, other component sizes are also contemplated by the present disclosure.

Returning to the discussion of FIG. 3, it may be desirable to provide power to a computing component from an unoccupied component interconnect port via a power adapter. For instance, some computing components, such as computing component 320, may use power exceeding that provided by interconnect slot 315a. Alternatively, even though sufficient power may be available via interconnect slot 315a, supplemental power may nevertheless be desired (e.g., such as to create a power buffer to keep power supply usage within an optimal efficiency band). Consequently, power adapter 300 may be connected to interconnect slot 315b and may provide supplemental power to computing component 320.

As should be apparent, power adapter 300 may be sized to fit within a space below an electromechanical space (shown with broken line 345) of computing component 320. As referred to herein, a power adapter, such as power adapter 300, that is sized to be arranged under an electromechanical space of a computing component refers to a height-limited adapter or a power adapter having a height-limited exposed portion.

FIG. 4 is a profile view of a sample power adapter 400 as compared with a sample computing component 420 and a sample component interconnect slot 415. The bracket labeled 445 indicates electromechanical space of component 420. The bracket labeled 455 indicates an exposed portion of power adapter 400 that may extend above interconnect slot 415 while power adapter 400 is connected thereto. And the bracket labeled 450 indicates an interconnect space of power adapter 400, such as may be inserted within interconnect slot 415. Thus, power adapter 400 may be considered a height-limited adapter if exposed portion 455 is small enough to fit underneath electromechanical space 445 of computing component 420. An example size of exposed portion may comprise approximately 6 mm or less, 5 mm or less, 4 mm or less, etc., by way of illustration but not limitation. Indeed, in other cases, an exposed portion of an example power adapter 400 may be greater than 6 mm (such as according to industry standards yet to be established, by way of example). For instance, in one such case, an exposed portion may comprise 7 mm or less, etc.

In one implementation of sample power adapter 400, therefore, an interconnect (e.g., interconnect 105 in FIG. 1), which may be located in interconnect space 450, may be connected to interconnect slot 415 to receive power from interconnect slot 415. In one example case, the interconnect may comprise a plurality of contacts (e.g., power and ground contacts) arranged to create an electrical connection with a contact arranged in interconnect slot 415 for transfer of power. Power adapter 400 may also comprise an output (e.g., output 110 in FIG. 1) to transmit received power to an auxiliary power connector of component 420, such as while component 420 is arranged in a second component interconnect slot. And, as noted above, sample power adapter 400 may be height-limited. As such, in one case, an exposed portion 455 of power adapter 400 may not extend into electromechanical space 445, shown as a portion of component 420 between dash-dot-dot line B and a top-most extremity of component 420. For example, as illustrated in FIG. 4, exposed portion 455 of example power adapter 420 refers to a portion of power adapter 420 visible above a top of interconnect slot 415 (e.g., indicated by dash-dot-dot line A), shown by dash-dot-dot line A′ on power adapter 420, to a top-most extremity of power adapter 420.

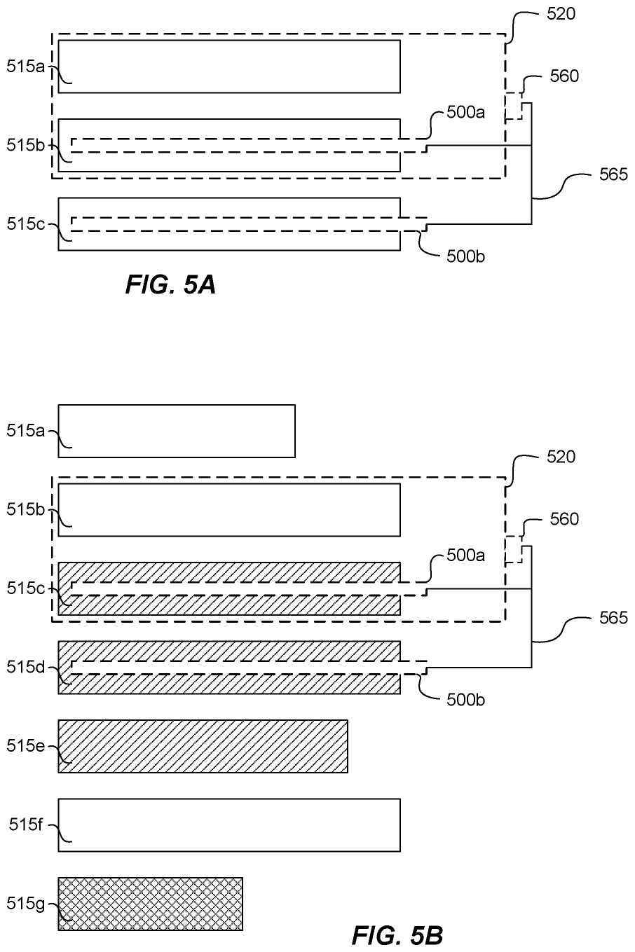

FIG. 5A illustrates a plurality of interconnect slots 515a-515c, such as may be arranged on a PCB. As shown, in one example case, a plurality of power adapters, power adapters 500a and 500b (shown with dotted lines, such as to not obscure other elements in the figure), may be used together to provide power to computing component 520 (also shown with a dotted line). FIG. 5A also shows a power cable 565 for transferring power from an output of power adapters (e.g., 500a and 500b) to an auxiliary power connector 560. While an example is shown using a plurality of power adapters, this is merely done by way of example and illustration. It should be understood that cases in which fewer or more power adapters may be used are contemplated by the present disclosure.

Turning to FIG. 5B, a diagram illustrates an example case in which a plurality of interconnect slots, interconnect slots 515a-515g are arranged, such as in an array on a PCB. In the example case illustrated in FIG. 5B, differing sizes of interconnect slots 515a-515g illustrate different throughput (e.g., x1, x4, x8, x12, x16, etc.) and interconnect versions (e.g., PCIe version 1.x, PCIe version 2.x, PCIe version 3.x, etc.). Differing fill patterns refer to different associations with differing processors of a PCB (e.g., a distinct motherboard processor or chipset, providing a PCIe root port supporting a different throughput for each interconnect slot, in this case). Thus, interconnect slot 515a may represent a PCIe3x4 slot (e.g., a PCIe version 3.x slot with x4 lanes) associated with a first processor socket; interconnect slot 515b may represent a PCIe3x16 slot (e.g., a PCIe version 3.x slot with x16 lanes of throughput) associated with the first processor socket; interconnect slot 515c may represent a PCIe3x16 slot (e.g., a PCIe version 3.x slot with x16 lanes of throughput) associated with a second processor socket; interconnect slot 515d may represent a PCIe3x16 slot (e.g., a PCIe version 3.x slot with x16 lanes of throughput) associated with the second processor socket; interconnect slot 515e may represent a PCIe3x8 slot (e.g., a PCIe version 3.x slot with x8 lanes of throughput) associated with the second processor socket; interconnect slot 515f may represent a PCIe3x16 slot (e.g., a PCIe version 3.x slot with x16 lanes of throughput) associated with the first processor socket; and interconnect slot 515g may represent a PCIe2x1 slot (e.g., a PCIe version 2.x slot with x1 lane of throughput) associated with a motherboard chipset, by way of example.

In the example illustrated in FIG. 5B, computing component 520 may be a dual-width graphical processing component connected to interconnect slot 515b. Two power adapters, power adapter 500a and power adapter 500b, may be connected to interconnect slots 515c and 515d, respectively, to provide supplemental power to component 520. Power cable 565 may transmit power from power adapters 500a and 500b, such as via an output of each respective power adapter, to auxiliary power connector 560. In the illustrated example case, the second processor socket, associated with interconnect slots 515c, 515d, and 515e, may be empty. Nevertheless, interconnect slots 515c, 515d, and 515e may be used to provide supplemental power to component 520 (e.g., even in cases in which the second processor socket is empty). As should be apparent, therefore, in one implementation, a plurality of height-limited power adapters may be used to provide power to a computing component.

Therefore, as disclosed herein, power to a computing component connected to a first component interconnect slot may be supplemented using a power adapter, which may be able to connect to a second component interconnect slot to provide the supplemental power. The power adapter may be height-limited, such as to be able to fit underneath an electromechanical space of the computing component. The power adapter may be able to provide power from an interconnect slot without data transmission via the same interconnect slot.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A power adapter for component interconnect ports comprising:
an interconnect portion to receive power from a first computing component interconnect port without transmitting or receiving data via the first computing component interconnect port; and
a power output portion for transmitting received power to a computing component.

2. The power adapter of claim 1, wherein the computing component is to be arranged within a second computing component interconnect port.

3. The power adapter of claim 2, wherein the power adapter comprises a height-limited exposed portion.

4. The power adapter of claim 3, wherein the power adapter with the height-limited exposed portion is to be arranged under an electromechanical space of the computing component.

5. The power adapter of claim 1 further comprising a power cable to connect the power output portion to an auxiliary power connector of the computing component.

6. A power adapter for computing component interconnect slots comprising:
an interconnect comprising a power contact to receive power from a first computing component interconnect slot;
an output to transmit received power to an auxiliary power connector of a computing component to be arranged in a second computing component interconnect slot; and
a height-limited exposed portion.

7. The power adapter of claim 6, wherein the computing component comprises a dual-width computing component and the height-limited adapter card is sized to fit under the dual-width computing component.

8. The power adapter of claim 6 further comprising a power cable connecting the output to the computing component.

9. The power adapter of claim 6, wherein the interconnect is to receive power signals without data signals from the first computing component interconnect slot.

10. The power adapter of claim 6, wherein the first computing component interconnect slot is connected to an empty processor socket.

11. A peripheral component interconnect express (PCIe) power adapter comprising:
a height-limited exposed portion;
an interconnect to receive power from a first PCIe slot on a printed circuit board (PCB); and
an output to transmit the received power to a component to be connected to a second PCIe slot on the PCB;
wherein the height-limited exposed portion is to extend from the first PCIe slot to below the electromechanical space of the component to be connected to the second PCIe slot.

12. The PCIe power adapter of claim 11, wherein the component to be connected to the second PCIe slot is to comprise a dual-width component.

13. The PCIe power adapter of claim 11, wherein the PCB is to comprise a first root port and a second root port, the first root port corresponding to the first PCIe slot and the second root port corresponding to the second PCIe slot, and further wherein the first root port is to comprise an empty processor socket.

14. The PCIe power adapter of claim 11, wherein the output is to be connected to an auxiliary power connector of the component to be connected to the second PCIe slot.

15. The PCIe power adapter of claim 11 further comprising a second height-limited adapter card having an interconnect to receive power from a third PCIe slot on the PCB and an output to transmit the received power to the component.
